(19) United States
(12) Patent Application Publication
(10) Pub. No.: US 2012/0124470 A1
(43) Pub. Date: May 17, 2012

(54) AUDIO DISPLAY SYSTEM

(75) Inventors: James E. West, Plainfield, NJ (US); Joshua Atkins, Santa Monica, CA (US); Thrasyvoulos N. Pappas, Evanston, IL (US); Andradige Silva, Evanston, IL (US)

(73) Assignee: The Johns Hopkins University, Baltimore, MD (US)

(21) Appl. No.: 13/299,148

(22) Filed: Nov. 17, 2011

Related U.S. Application Data
(60) Provisional application No. 61/414,613, filed on Nov. 17, 2010.

(51) Int. Cl. G06F 3/16; G06F 3/01

(52) U.S. Cl. 715/702; 715/727

(57) ABSTRACT

An audio display system includes a pointing device configured to address locations within an interaction field, a sound system adapted to communicate with the pointing device, and—an object mapping unit adapted to communicate with the sound system. The object mapping unit is configured to generate a map identifying locations within the interaction field that correspond to a representation of an object to be displayed such that the interaction field is segmented into an exterior region and an interior region of the representation of the object. The sound system is configured to provide an object-locating sound when the pointing device addresses a location in the exterior region so as to guide a user to further address the interaction field at least one of closer to or further away from the interior region of the object.

### CROSS-REFERENCE OF RELATED APPLICATION

This application claims priority to U.S. Provisional Application No. 61/414,613 filed Nov. 17, 2010, the entire contents of which are hereby incorporated by reference.

### BACKGROUND

1. Field of Invention

The field of the currently claimed embodiments of this invention relates to display systems, and more particularly to audio display systems that provide information of representations of objects using sound.

2. Discussion of Related Art

With the ever increasing availability of the Internet and electronic media rich in graphical and pictorial information—for communication, commerce, entertainment, art, and education—it has been hard for the visually impaired (VI) community to keep up. The use of one or more functioning senses to convey information in another sense is defined as sensory substitution (SS). There are two main types of SS: invasive methods and non-invasive methods. Invasive methods generally require surgery, e.g., sensory prosthesis. The cortical or retinal electrode matrix display is a popular invasive approach for visual substitution (P. B. L. Meijer, “Sensory substitution—vision substitution,” http://www.seeingwithsound.com/sensub.htm, October 2010), while Braille is a non-invasive approach. Another SS approach that has proven to be quite effective in providing visual information and assisting visually impaired people with certain visual tasks is the use of a tongue display (P. Bach-y-Rita, K. A. Kaczmarek, “Tongue placed tactile output device,” U.S. Pat. No. 6,430,450; August 2002). It consists of an array of electrodes that can apply different voltages to stimulate the tongue, which is the most sensitive tactile organ and has the highest spatial resolution. However, the majority of visually impaired people find such presentations—as well as the presentation of electrical and other tactile stimuli on other parts of the body (back, abdomen)—quite invasive, and prefer to scan/explore with the finger.

Out of the five senses, vision has the highest bandwidth followed by hearing, touch, taste, and smell. Gustatory (taste) and olfactory (smell) sensors suffer from remarkably slow recovery times and are also more prone to adaptation than others, making it hard to utilize them in VS. This leaves three alternatives for VS: solely by touch, solely by hearing, and by both touch and hearing. The simplest navigational aid based on touch and hearing would be a long cane, which is used by the majority of VI community. It was shown that VI can acquire spatial abilities by using maps, which can also be used as a navigational aid, e.g., to plan the route before to walking (S. Ungar, S. Blades, and C. Spencer, “The role of tactile maps in mobility training,” British J. Visual Impairment, vol. 11, pp. 59-61, July 1993). Jacobson implemented an audio enabled map in a touch pad, which uses voice and natural sounds (D. R. Jacobson, “Navigating maps with little or no sight: A novel audio-tactile approach,” Content Visualization and Intermedia Representations, 1998). NOMAD (1988) (Meijer), “Talking Tactile Maps” (1994) (Meijer), and “Talking Tactile Tablet” (S. Landau, L. Wells, “Merging tactile sensory input and audio data by means of the talking tactile tablet,” Euro-Haptics. IEEE Computer Soc., 2003, pp. 414-418) are tactile maps that play back an auditory label depending on the position touched. However, these systems are not well-suited to interactive applications. Parente et al. (P. Parente, G. Bishop, “Bats: The blind audio tactile mapping system,” Proc. ACM South Eastern Conf., 2003) have developed an audio-haptic map using spatial sounds in 3D. Several auditory counterparts of GUIs such as, Soundtrack by Edwards (1989), Karshmer and Oliver's system (1993), GUIB by Savidis and Stephanidis (1995), and Mercator Project by Mynatt (1997), are also available (Jacobson). Meijer's imaging system named “vOICe,” maps a 64x64 image with 16 gray levels to a sequence of tones (P. B. L. Meijer, “An experimental system for auditory image representations,” IEEE Tr. Biomed. Eng., vol. 39, no. 2, pp. 112-121, February 1992; P. B. L Meijer, “See with your ears!—the voice,” http://www.seeingwithsound.com, October 2010). Another imaging system called “soundview” was developed by Doel (K. V. D. Doel, “Soundview: Sensing color images by kinesthetic audio,” Int. Conf. Auditory Display. IEEE, 2003, pp. 303-306), where the user explores a color image loaded to a tablet with a pointer; the color of each pixel color is mapped to a sound in the tablet. However, the utility of these devices are quite limited. There thus remains a need for improved visual substitution systems.

### SUMMARY

An audio display system according to an embodiment of the current invention includes a pointing device configured to address locations within an interaction field, a sound system adapted to communicate with the pointing device, and—an object mapping unit adapted to communicate with the sound system. The object mapping unit is configured to generate a map identifying locations within the interaction field that correspond to a representation of an object to be displayed such that the interaction field is segmented into an exterior region and an interior region of the representation of the object. The sound system is configured to provide an object-locating sound when the pointing device addresses a location in the exterior region so as to guide a user to further address the interaction field at least one of closer to or further away from the interior region of the object.

A method of providing an audio display according to an embodiment of the current invention includes generating a map identifying locations within an interaction field that correspond to a representation of an object to be displayed such that the interaction field is segmented into an exterior region and an interior region of the representation of the object, receiving an input signal from a pointing device addressing a location within the interaction field, and providing an object-locating sound with a sound system when the pointing device addresses a location in the exterior region so as to guide a user to further address the interaction field at least one of closer to or further away from the interior region of the object.

A computer-readable medium for providing an audio display according to an embodiment of the current invention includes computer-executable code which when executed by a computer causes the computer to generate a map identifying locations within an interaction field that correspond to a representation of an object to be displayed such that the interaction field is segmented into an exterior region and an interior region of the representation of the object, receive an input signal from a pointing device addressing a location within the interaction field, and provide instructions to a sound system to produce an object-locating sound when the pointing device addresses a location in the exterior region so as to guide a user to further address the interaction field at least one of closer to or further away from the interior region of the object.

An audio display system according to an embodiment of the current invention includes a pointing device configured to address locations within an interaction field, a sound system adapted to communicate with the pointing device, and an object mapping unit adapted to communicate with the sound system. The object mapping unit is configured to generate a map identifying locations within the interaction field that correspond to a representation of an object to be displayed using sound such that the interaction field is segmented into an exterior region and an interior region of the representation of the object.

An audio navigation system according to an embodiment of the current invention includes a pointing device configured to address locations within an interaction field, a sound system adapted to communicate with the pointing device, and an object mapping unit adapted to communicate with the sound system. The object mapping unit is configured to generate a map identifying locations within the interaction field that correspond to a representation of an object. The sound system is configured to provide directional sounds for navigation using at least one of a general or, a personal head related transfer function.

### BRIEF DESCRIPTION OF THE DRAWINGS

Further objectives and advantages will become apparent from a consideration of the description, drawings, and examples.

FIG. 1 is a schematic illustration of an audio display system according to an embodiment of the current invention.

FIG. 2 is a schematic illustration of an audio display system according to another embodiment of the current invention.

FIG. 3 is a schematic illustration of an audio display system according to another embodiment of the current invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

According to some embodiments of the current invention, tactile and acoustic interaction can be used for visual substitution (VS) as well as to provide multisensory experience (ME), combined with other senses. Embodiments of the current invention are non-invasive and involve active user exploration, such as by an index finger of the user. For example, objects can be located and their shapes determined using auditory feedback as the user scans the screen with a finger. Both tactile-acoustic display and input (speech commands, finger pointing or tapping) can be used in VS or ME. Embodiments of the current invention can have a broad range of applications, such as, but not limited to, virtual reality, immersive environments, e-commerce, tele-conferencing, human-computer interaction, medicine and as an aid for the visually impaired (VI). For example, an embodiment that includes a touch screen can be used to convey 2-D and 3-D graphical and pictorial information (i.e. graphs, diagrams, charts, photos, and video) to the VI. Some embodiments of the current invention can enable a VI person to navigate in an environment or perceive graphical and/or pictorial information. Tactile feedback can be rendered by vibration, dynamic surface deformation, etc., while acoustic features like timbre, pitch, frequency, loudness, roughness, directionality, etc. can be used to convey additional information. For example, in gaming, the user can be immersed in the environment via the use of tactile patterns and vibrations, directional sounds and other acoustic features that provide realistic rendering of various elements of the environment, such as characteristic sounds, and warnings of approaching objects (e.g., by increasing tempo when objects are approaching and decreasing tempo when they are moving away). The same concepts can be used to augment existing displays to include the user's auditory and tactile awareness into the interface.

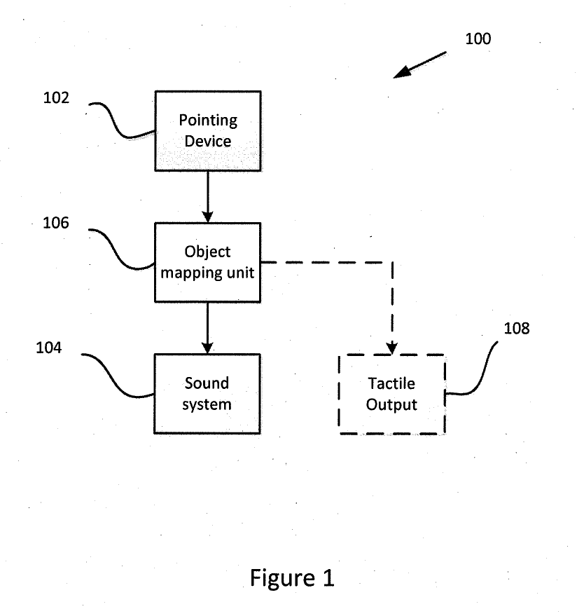

FIG. 1 provides a schematic illustration of an audio display system 100 according to an embodiment of the current invention. The audio display system 100 includes a pointing device 102 configured to address locations within an interaction field, a sound system 104 adapted to communicate with the pointing device 102, and an object mapping unit 106 adapted to communicate with the sound system 104. The object mapping unit 106 is configured to generate a map identifying locations within the interaction field that correspond to a representation of an object to be displayed such that the interaction field is segmented into an exterior region and an interior region of the representation of the object. The sound system 104 is configured to provide an object-locating sound when the pointing device addresses a location in the exterior region so as to guide a user to further address the interaction field at least one of closer to or further away from the interior region of the object.

The term “object” is intended to cover any physical two-dimensional or three-dimensional object of the type that could be imaged onto a video screen, for example. However, actual video imaging is not required in all embodiments of the current invention, but could be included, if desired. The term “object” can also include symbolic “objects” such as alpha-numerical and/or mathematical symbols, for example. The term “object” can also include three dimensional objects that can be mapped onto a three-dimensional interaction field. Two-dimensional objects and interaction fields can be obtained as projections or cross-sections of three-dimensional objects and interaction fields.

In one embodiment, the pointing device 102 can be a touch-sensitive screen. For example, touch-sensitive screens currently available in tablet computers or smart phones can be used as a pointing device 102. However, the pointing device 102 is not limited to only touch-sensitive screens. For example, a surface-operable mouse can also be used in some embodiments. In other embodiments, an aerial mouse for addressing locations within a three-dimensional field can be used. In further embodiments, the pointing device 102 can be a wearable location device. For example, the wearable location device can include at least one of an accelerometer or a gyroscope. The accelerometer and/or gyroscope can be one-axis, two-axis or three-axis systems, depending on the number of degrees of freedom desired for the particular application. The pointing device can be activated by hand-operable controls, such as buttons, switches, etc., and/or could be operated in other ways such as voice, for example.

The term “interaction field” is intended to have a broad meaning to include one-dimensional, two-dimensional and/or three-dimensional fields, depending on the particular application. For example, in the case of a flat touch screen, the interaction field corresponds to the touch screen surface. In the case of an aerial mouse or a wearable location device, the interaction field would typically be a three-dimensional field.

The object mapping unit 106 can be implemented on an electronic device such as, but not limited to, a computer, e.g., a work station, a desk-top computer, a lap-top computer, a tablet and/or a smart phone. The object mapping unit 106 can also be implemented in a specialized portable, hand-held and/or wearable device in other embodiments of the current invention. In an embodiment of the current invention, the pointing device can be a tablet computer. In an example, suppose the tablet computer images a circular disk on the touch screen. The mapping unit in this example will segment the image into interior and exterior regions of the disk. However, it is important to note that the formation of the visual image, although possible and within the general concepts of the invention, is not required. If the device is for use exclusively by a person who has complete loss of vision, it may not be necessary to perform any visual imaging. The object mapping unit nonetheless provides the map of the interaction field that can be addressed by the pointing device 102. In other embodiments, the map may not coincide with an image at all. For example, in the case of a mouse, the map is typically in a different position and orientation relative to a video screen. The video screen could be included as a component of the audio display device 100, but it is not required in all embodiments. In the case of an aerial mouse, or a wearable pointing device, the interaction field can be a three-dimensional volume such that the interior region of the object is located in free space, for example.

According to some embodiments of the current invention, the object-locating sound varies in at least one of amplitude, frequency, modulation, pulse repetition rate, pulse duty factor, perceived source direction, or reflection time delay in order to convey information to the user of a relative position or change in position relative to the object. Some embodiments will be described in more detail below; however, the general concepts of the current invention are not limited to the particular embodiments.

According to some embodiments of the current invention, the sound system 104 is configured to provide an object-specific sound when the pointing device 102 addresses a location in the interior region of the object. For example, the object-specific sound can be indicative of at least one of a material, a shape, a structure or a function of the object.

According to some embodiments of the current invention, the object mapping unit 106 is further configured to segment the interaction field to include a perimeter region of the representation of the object and the sound system is configured to provide a perimeter sound when the pointing device addresses a location in the perimeter region of the object.

The object mapping unit 106 is not limited to mapping just one object. For example, two objects, three objects or more could be mapped. In this case there can be overlapping regions, such as an interior region of one object may overlap with a portion of an exterior region of another object, or portions of exterior regions of two or more objects may overlap. Sounds can be used to provide guidance towards certain objects, and away from other objects, for example. In addition, the representation of the object to be displayed through the use of sound can be a dynamically generated representation, similar to dynamically generated video representations on a video display. For example, the dynamic representation can be changing in at least one of orientation, position, size, shape or configuration of the representation of the object. This can be analogous to a slide show or a fully animated display, but providing an audio display in which audio information is used to convey information about the objects being displayed.

The sound system 104 can include one or more speakers in some embodiments. The speakers can be integrated with the pointing device, such as in a tablet or lap top computer, or a smart phone. Alternatively, or in addition, the speakers can be separate speakers. In other embodiments, the sound system 104 can include head phones instead of, or in addition to, speakers. In some embodiments, the headphones can also include a location device such that the pointing device 102 is integrated with a portion of the sound system 104.

In some embodiments, the audio display system can include output devices for conveying information through other senses, such as visual and/or tactile information. For example, in an embodiment in which the pointing device has a touch-sensitive screen, an embossed layer of material can be placed over the touch-sensitive screen to serve as a tactile output device adapted to stimulate a sense of touch of a user. For example, embossed paper or plastic sheets, or other material could be placed on or attached to the surface of the touch-sensitive screen. Materials, thicknesss, etc. can be selected such that the embossed layer of material does not interfere with the operation of the touch screen.

In some embodiments of the current invention, a tactile output device 108 can be included in the audio display system 100. The tactile output device 108 can be at least one of a structured material suitable to be touched by a user, a vibration device integrated with the pointing device, or a vibration device that is adapted to be attached to or worn by the user.

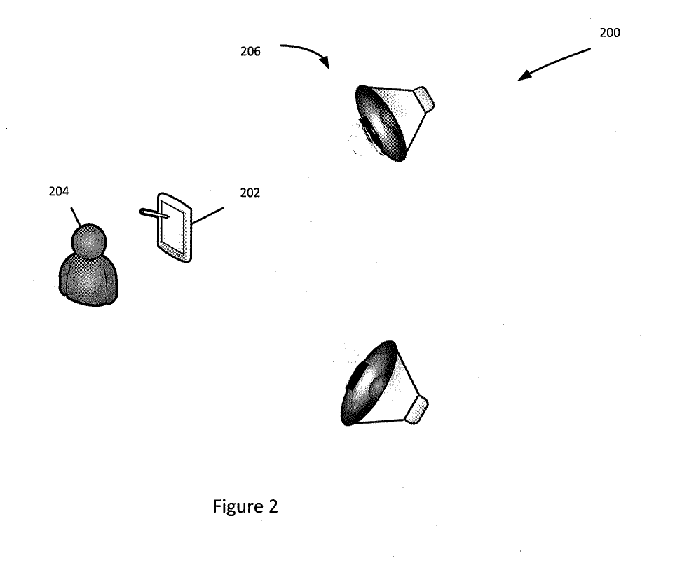

FIG. 2 provides a schematic illustration of an audio display system 200 according to another embodiment of the current invention. In this embodiment, a tablet computer 202 has a touch-sensitive screen to provide a pointing device that can be operated by user 204. The tablet computer 202 is programmed to provide an object mapping unit. The tablet computer 202 can include at least a portion of a sound system. The tablet computer can also be programmed to perform the signal processing of the sound system to drive either built in speakers, external speakers 206, and/or headphones.

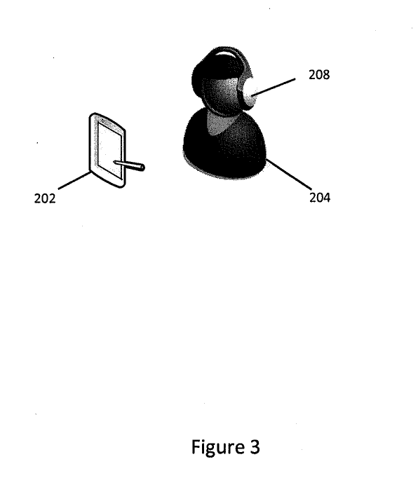

FIG. 3 is a schematic illustration of a variation of the audio display system 200 in which headphone 208 are include instead of, or in addition to, external speakers 206.

Another embodiment of the current invention is directed to a computer-readable medium for providing an audio display. The computer-readable medium includes computer-executable code which when executed by a computer causes the computer to generate a map identifying locations within an interaction field that correspond to a representation of an object to be displayed such that the interaction field is segmented into an exterior region and an interior region of the representation of the object; receive an input signal from a pointing device addressing a location within the interaction field; and provide instructions to a sound system to produce an object-locating sound when the pointing device addresses a location in the exterior region so as to guide a user to further address the interaction field at least one of closer to or further away from the interior region of the object.

The follow describes some particular embodiments of the current invention for conveying visual information in acoustic and tactile-acoustic form. These are provided to help explain some concepts of the current invention. The scope of the current invention is not limited to these particular embodiments. In all of these examples, a subject interacts with a touch screen and listens to auditory feedback via headphones. The touch screen is partitioned into regions, each with a particular sound field. Each region represents an object, part of an object, or other element of a visual scene or graph. The user actively explores the screen with her/his finger, while listening to auditory feedback.

### Embodiment 1: Basic Object Shape Identification with Two or Three Constant Sounds

The screen is divided into two segments; inside the object and outside. One sound is played when the subject's scanning finger is inside the object and the other when finger is outside. We have shown that it is possible to identify simple shapes, a circle, a rectangle, and a triangle using two sine waves separated by an octave. All the inventors were able to determine the shapes after a few trials; a 12 year old easily found the shapes; others were also able to determine the shapes, some with difficulty, others with ease. In another embodiment, we improved object detectability by using wide-band natural sounds instead of sine waves, based on the observation (E. A. Björk, Laboratory annoyance and skin conductance responses to some natural sounds. Journal of Sound and Vibration 109 2 (1986), pp. 339-345) that humans show less annoyance to such sounds. In the third version, we added a narrow strip around the border of the object, thus increasing the number of segments to three. The introduction of a special border sound is intended to encourage the subjects to track the boarder, which makes it easier to detect the object shape.

### Embodiment 2: Basic Object Shape Identification with Amplitude Modulation (Tremolo)

An amplitude modulation signal with varying rate and depth (depending on the finger's position), sometimes referred to as “tremolo,” is used. Two depth values, one inside and one outside the object are used. There is also a border region (strip) within each segment (object and background). The tremolo rate is constant within each segment, except when the finger enters the border region, where it increases as the finger approaches the border. Again, the changes near the border are intended to help the subject locate and follow the border.

### Embodiment 2a: Basic Object Identification with Loudness

This configuration is a hybrid of configurations one and two. There are three segments (outside, border and inside), and to distinguish them we assign three different sounds to those three segments as we did in configuration one.

In this configuration, the volume of the sound played when the user's finger is in the border drops exponentially with the distance of the finger from the center line of the border, hence having the maximum volume at the center of the border and the minimum at the edges of the border. We like to see an analogy with raised line perception, where the raised line is a ridge which has the maximum relief at the center and relief decays exponentially with the distance from the center.

### Embodiment 3: Object Shape Identification via Touch and Sound

An alternative approach is to rely on touch for shape identification, and to use sound for material identification. For the time being, this can be done by two main ways, i.e. by superimposing a piece of paper with an embossed tactile pattern onto the iPad, iPodTouch, or other touch screen or by programming a vibrating pattern that super imposes with the acoustic pattern. In the first way, note that the position of the finger can be sensed through the paper. For the latter, we can either set the screen to vibrate or we can have the user wear a tiny vibrator on his/her scanning finger. Either way, this approach makes use of the psychology of ear training to associate certain sounds with objects. For example the difference in rubbing fingers across silk and cotton can be important, such as using a “smooth” sound for the silk and a more rough sound for cotton. Real sounds can also be used as playbacks, i.e., rubbing cotton/silk, tapping wood/glass/metal etc., as opposed to synthetic according to some embodiments. A substantial dictionary can be constructed, if desired. Also, artificial sounds and/or real sounds in artificial responses can also be used. An example is stairs represented by a bump-bump sound using frequency changes to indicate ascending and descending ramps during finger scan.

### Embodiment 4: Basic Object Shape Identification with HRTF

Directionality can be introduced to border and outside sounds with Head Related Transfer Function (HRTF) of the user to guide the scanning finger. The sound is now played back via stereo head phones. It can be tailored with personal HRTF or the best match with general HRTF's by calibrating the subject with known directional sound. Directional SONAR pings, which have been found to work best in navigation tasks (Tran, T. V., Letowski, T. And Abouchacra, K. S. 2000, Evaluation of acoustic beacon characteristics for navigation tasks, Ergonomics, 43, 807-827), are used for the outside background region to guide the finger to the closest point on the object. Directional (chirp or other) sounds in the border are used to guide the user while tracing the border. Finally, the sounds played inside the shape are non-directional, natural, and wide-band.

Specifically, the screen is divided into three segments (object, background, and border region), each with its own unique sound. When the finger is in inside the object, the sound is constant. When the user scans the background (outside) segment, a 2D virtual acoustic scene is formed. In the 2D plane of the touch screen, the virtual listener (the subject) is assumed to be in the position of the scanning finger, facing north. The sound source (which emits the assigned unique sound for the object) is assumed to be located inside the object at the point nearest to the finger (not at the center of the object). To render this virtual acoustic scene, an averaged (over subjects) Head Related Impulse Response (HRIR) signal from the CIPIC HRTF database is utilized (Algazi, V. R., Duda, R. O., Thompson, D. M., and Avendano, C. (2001). The CIPIC HRTF Database, IEEE Workshop on Applications of Signal Processing to Audio and Acoustics, New Paltz, N.Y., pp. 99-102). To implement the sound directionality, the plane of the touch screen, with the listener at the center is uniformly divided in to 12 pie slices of 30 degrees each. The source position with respect to the listener is then determined and the source will be assigned to one of the 12 pie slices. Then the sound wave is convolved with the corresponding HRIR. The resultant wave is played back via stereo headphones; the volume of the playback will be decaying exponentially with the distance between the listener and the source. When scanning the border segment, the same assumptions hold for the virtual listener as in the background segment, but the sound source (which emits the sound assigned to border segment) is placed in the direction that the user needs to follow in order to keep tracking the border clockwise. In other words, when the user is inside the border segment she/he should move the finger in the direction from which the sound is coming in order to continue tracing the border.

### Embodiment 5: Scene Perception by Virtual Cane

The system operates in two modes; zoomed-out and zoomed-in. In the zoomed-out mode, a number of disjoint objects are placed in the touch screen. A characteristic sound is assigned to each object. When the user's finger is inside an object, the sound assigned to that object is played back; when the finger is in the background region, there is no sound. This can be thought of as a blind person exploring a scene (e.g., an outdoor scene outside her/his window), using a virtual cane (a very long cane in the case of the outdoor scene) to tap on the objects. To simulate this scenario, a prerecorded tapping sound is assigned to each object, and is played back when the finger is scanning the object. In the zoomed-out mode, the user gets information about the position of each object, the material it is made of, and some idea about its shape. To further explore the shape of a selected object in finer resolution, the user can enter the zoomed-in mode by double-tapping inside the object. In this mode only the chosen object is present and it is zoomed-in at the center of the screen. The zoomed-in mode functions exactly as described in embodiment 4. The user can go back to the first mode by double-tapping anywhere in the screen. A special sound will be played whenever a mode toggle takes place, to verify the mode change.

### Configuration 6: Scene Perception a la Active SONAR

Here we describe a different type of exploration by the user, similar to the operation of active SONAR. The HRTFs will be used to render a useful spatial image to the listener, based on the reflections off of objects in the environment. The touch screen will be used as a joystick to navigate the environment. The finger's position on the touch screen represents a scanning source in the Active SONAR analogy. Any type of source directionality can be simulated; omnidirectional (point source), far field (plane-wave), or varying width beams. Point source scanning (omnidirectional beam) can be used to derive macroscopic impressions of the scene, while plane waves can provide a more detailed rendition of the scene. The user then listens for reflections from the objects in the scene. The HRTF over the headphones allows the listener to determine the directions of the reflections from objects and to some degree their size and shape. Moving the finger toward one of the objects can be used as a signal to zoom-in, making the shape and size more “visible.”

Note that since there is no actual sonar transmission, we need not adhere to the laws of physics as far as the properties of sound and human hearing are concerned, much like cartoons use their own physical laws. For example, objects (and the environment) can be scanned at frequencies above the range of hearing; the reflections can be heard by transposing the reflections to lower frequencies, forming a new type of auditory stimulus. We can even form a laser beam of sound to resolve minute changes in shape, subtle characteristics of a human face for example. We can fashion fan-like beams to scan larger objects with sharp resolution much like MRI resolves thin slices of an object.

### 3D Rendering of a Scene

We can think of a 2D scene as a projection of a 3D scene to that specific 2D plane. Thus, the user can observe the 3D scene by exploring several 2D slices of it. Using two fingers to scan the scene, the user can enter a special mode of operation where she/he can change the altitude of the 2D plane to which the 3D scene is projected. This can be done in a number of ways, e.g., by moving the iPOD/iPad vertically up and down

### Other Modes of Operation

We can make use of the ability to generate mechanical vibration to indicate approaching danger or other alerts, or even surface texture. Users can easily zoom-in and out the scene by pinch in and out gestures of the touch screen to explore scene in multiple resolutions, in that way both micro or macro details are readily available. Finally, GPS can provide the location of the device (the current location of the VIU) and the accelerometer can detect its orientation, which combined with GIS enabled maps, can convert the system into a safe navigation system for VIUs.

### Complete Sense Substitution System

In another embodiment, one can take a picture or video of an indoor scene (containing normal objects, like a book case, chairs, tables, etc.) or an outdoor scene (containing trees, buildings, cars, etc.) by a camera built into the device; process the photo by segmentation and segment classification to simplify it so that it can be projected onto the touch screen and display the scene in acoustic or tactile-acoustic form.

Some embodiments can be useful for products to aid visually impaired people navigate and explore their environment, perceive information in graphical form such as charts/graphs, sketches and maps, and to visualize a vast amount of data available in electronic form (e.g., on the Internet, e-books, accessories like mobile phones or PDAs, digital image repositories, etc.). It could also have a major impact on sighted people for situations in which they are unable to utilize vision. For example visual information can be presented in acoustic-tactile form under the cover of darkness. Embodiments can also be useful for spatialized sound in order to overcome cognitive blindness in visually impaired children (as in (Sánchez, J., Lumbreras, M., and Cernuzzi, L. 2001. Interactive virtual acoustic environments for blind children: computing, usability, and cognition. In CHI '01 Extended Abstracts on Human Factors in Computing Systems (Seattle, Washington, Mar. 31-Apr. 5, 2001). CHI '01. ACM, New York, N.Y., 65-66. DOI=http ://doi.acm.org/10.1145/634067.634109)). Other embodimens can be used to provide total experience to users by using it to render multi-sensory perception, especially in virtual environments. In addition, some embodiments can have an impact in virtual reality and immersive environments (touch and sound in combination with visual information).

The following specific examples are presented to help explain some concepts of the current invention in more detail. However, the broad concepts of the current invention are not intended to be limited to the specific examples.

### EXAMPLES

The focus of the following examples is on non-invasive methods for visual substitution (VS), using the finger. In this embodiment, the user actively explores a two-dimensional layout consisting of one or more objects on a touch screen with a finger while listening to auditory feedback. In addition to their utility for the VI community, such VS methods are expected to be of use in situations where vision cannot be used, e.g., for GPS navigation while driving, fire-fighter operations in thick smoke, and military missions conducted under the cover of darkness.

The software for the application makes use of available apple libraries, such as CoreAudio, AVFoundation etc. available from the Apple development environment, libraries from the Android development environment and open source libraries such as Open AL, Open GL etc. In 3D scene perception, Software will simulate the virtual 3D audio environment of source, subject and reflecting objects to play appropriate reflected sound to the user. It is by the software, that all the built in sensory inputs of iPhone or other display/pointing device (GPS, accelerometer, compass, blue-tooth/wi-fi, multi-touch inputs etc.) and responses (vibration, 3D localized sounds etc.) are controlled according to the application's requirements. The algorithm that is implemented by software can also be critical. For example, when the user has multiple fingers touching the screen, it is up to the underlying algorithm to decide which finger to follow as the pointer, or to detect a zoom-in/out action etc.

One of the tasks of the software for some embodiments is to perform all the signal processing (generating sounds, vibrations etc.) and general processing desired by the application efficiently and effectively, only utilizing the limited hardware and firmware resources of mobile device.

### Subjective Experiments

Ten subjects took part in a series of experiments, in which they interacted with a touch screen (Apple iPad) and listened to auditory feedback. The average age of the subjects was 31, ranging from 19 to 50; all reported normal or corrected vision and normal hearing. To prevent visual contact with the touch screen and the scanning finger, the screen is placed in a small box open in the front, so that the subject can put her/his hand inside to access the screen. The subject was seated in front of a table on which the box and the touch screen was placed, and was listening to sounds played back via stereo headphones (SENNHEISER HD595). The experiments were performed in a reasonably quiet room to avoid disturbances. Subjective experiments were conducted for all five configurations. Before the beginning of the trials for a given configuration, the subject was given a written introduction about the experiment and a chance to ask questions. To become familiar with the system, the subject was first shown a training example, during which, the subject was able to see both the scanning finger and the shape on the touch screen. The subject was also asked to explore the training example under the box, in order to get used to the experimental procedure. There was no tight time limit for each experiment, but the actual time durations were recorded. Each of the first four configurations was tested with three shapes, a square, circle, and equilateral triangle. Each shape was centered in the touch screen and had approximately the same area in square pixels. The subjects didn't have any prior knowledge about the shapes they were going to be tested on, and the ground truth was not revealed until the end of the experiments. The sequence of the trials was randomized, both among configurations and subjects. The subjects were told that the shape they were going to be tested on in any given trial could be the same as that in a previous trial, or a new one altogether. At the end of each trial, the subject was first asked to draw the shape and then to name it. Subjects were then asked for comments. The fifth configuration was tested with a scene consisting of three objects with a tapping sound of wood, glass, and metal assigned to each. At the completion of the experiment, the subjects were asked to write down the number of objects in the scene, to identify the material of each object, and to indicate their relative positions.

### Experimental Results and Discussion

The results of the subjective experiments are presented in Table 1. The overall accuracy (averaged over all shapes, configurations and subjects) among all trial results was 74.2%. The percent accuracy for the three shapes in the four embodiments, is significantly greater than what would be achieved by mere guessing. The results are strengthened by the fact that the subjects didn't have any prior knowledge about the shapes they were going to be tested on.

TABLE 1
Subjective Results

| | Configuration 1 | | | Configuration 2 | | | Configuration 3 | | | Configuration 4 | | |
|---|---|---|---|---|---|---|---|---|---|---|---|---|
| | Square | Circle | Triangle | Square | Circle | Triangle | Square | Circle | Triangle | Square | Circle | Triangle |
| Accuracy | 90% | 30% | 80% | 80% | 70% | 80% | 80% | 40% | 90% | 100% | 60% | 90% |

| | | | | |
|---|---|---|---|---|
| (overall) | 66.7% | 76.7% | 70.0% | 83.3% |

The average accuracies for each shape (across configurations and subjects for each shape) were: square 87.5%, circle 50.0%, triangle 85.0%. These figures clearly show that the subjects had more difficulty identifying the circle over the other two shapes. This indicates that the detection of curved edges is more difficult than that of straight edges. However, we should point out that the training example always had the same shape (cross) with only straight edges, which may have created the expectation of shapes with straight edges. In fact, when they were asked to draw the shape they experienced, two out of ten subjects attempted to approximate the circle with straight lines. Note that a 10% increase in accuracy for the second configuration over the first, justifies the addition of the narrow strip with distinct sound around the border. Since tracing the edge (of the shape) is easier in the second configuration than the first, the increase in performance may also be used to infer that the subjects preferred tracing the edge in identifying the shape. On the other hand, the addition of proximity feedback via tremolo didn't work out as expected, as can be seen by the drop in performance for Embodiment 3, compared to Embodiment 2. Perhaps the proximity information inside a relatively narrow border strip (50 pixels wide) was not helpful in carrying out the task. A more likely explanation, however, is that the tremolo signal is not optimal for this task. Indeed, some of the subject's comments, such as “inside/outside of shapes were not differentiable by assigned tremolos,” “tremolo rate changes very fast within a small area,” “tremolo rate changes were not noticeable,” favor the latter argument. Finally, the superior performance of the fourth configuration, is due to the addition of spatial sounds. Yet, as some comments reveal, the addition of spatial sounds to the background was not of much use and it was the spatiality of the border strip sound which helped them. Since the shapes were always centered and occupied much of the screen, locating the shape in background (which was the intention behind adding spatiality to background sounds), might not be a challenging task. Spatial sounds in the border segment, on the other hand, are quite useful in guiding the finger in edge tracing and also provide clues about edge orientation. Having directionality as guidance in tracing the edge, might have relieved the subject from the task of exploring and allowed her/him to focus more on identification, as Wijntjes et al. (M. W. A Wijntjes, et al., “Look what I have felt: Unidentified haptic line drawings are identified after sketching,” Acta Psychologica, vol. 128, no. 2, pp. 255-263, 2008) explained. In Embodiment 5, the accuracy of detecting the number of shapes in the scene was 100%. The subjects were able to locate the wooden object with 90% accuracy, the glass object with 80%, and metal object with 70%. Glass was confused with metal 10% of the time, and vice-versa 20% of the time as the sounds we used for the two were not easy to distinguish.

In the future, we plan to use more distinguishable sounds, even if not as realistic. We now compare our results with those reported in (K. V. D. Doel, et al., “Geometric shape detection with soundview,” Int. Conf. Auditory Display, 2004). In “soundview” they used two sounds, one inside the shape and one in the background. However, the sound played to the subject at a given time depended on both the location and the velocity of the pointer. In addition, they used six shapes (square, circle, and triangle, with and without a hole in the middle). In contrast to our experiment, they allowed subjects to have visual contact with the tablet and scanning pointer, thus using vision in shape identification—which is unrealistic for VI subjects. They used three different experimental procedures. In the first, the subjects didn't know the test shapes, and they had to draw the shape after each trial. In the second, the participants were asked to choose the shape they perceived among 18 shapes. In the third, they had to pick one among the six possible shapes. The overall accuracy for the three experiments was 30.0%, 38.3% and 66.2%, respectively. They also tested “vOICe” with the third experimental procedure and got overall accuracy of 31.0%. With the exception of the number of shapes, we may say that their experiments were comparable or easier than ours. However, our results are clearly better.

In conclusion, we have invented a new approach for conveying graphical and pictorial information without utilizing vision, and proved its applicability in perceiving basic geometric shapes, significantly outperforming existing approaches. Other applications can include navigation, map perception, and imaging, for example. We have also shown that a basic scene can be perceived and objects can be located, identified and distinguished using a “virtual cane.” To further explore the shape of a selected object in finer resolution, we can include a zoomed-in mode that can be triggered by double-tapping inside the object.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. An audio display system, comprising:
a pointing device configured to address locations within an interaction field;
a sound system adapted to communicate with said pointing device; and
an object mapping unit adapted to communicate with said sound system,
wherein said object mapping unit is configured to generate a map identifying locations within said interaction field that correspond to a representation of an object to be displayed such that said interaction field is segmented into an exterior region and an interior region of said representation of said object,
wherein said sound system is configured to provide an object-locating sound when said pointing device addresses a location in said exterior region so as to guide a user to further address said interaction field at least one of closer to or further away from said interior region of said object.

2. An audio display system according to claim 1, wherein said sound system is configured to provide said object-locating sound for physical navigation through a field of objects by correlating movement with the said pointing device.

3. An audio display system according to claim 1, wherein said object-locating sound varies in at least one of amplitude, frequency, phase, intensity, modulation, pulse repetition rate, pulse duty factor, timbre, tempo, perceived source direction and/or distance, or reflection time delay.

4. An audio display system according to claim 1, wherein said sound system is configured to provide an object-specific sound when said pointing device addresses a location in said interior region of said object.

5. An audio display system according to claim 1, wherein said object-specific sound is indicative of at least one of a material, a shape, a texture, a color, a structure or a function of said object.

6. An audio display system according to claim 1, wherein said object-specific sound is a speech callout.

7. An audio display system according to claim 1, wherein said object mapping unit is further configured to segment said interaction field to include a perimeter region of said representation of said object, and
wherein said sound system is configured to provide a perimeter sound when said pointing device addresses a location in said perimeter region of said object.

8. An audio display system according to claim 7, wherein said perimeter sound varies in at least one of amplitude, frequency, phase, intensity, modulation, pulse repetition rate, pulse duty factor, timbre, tempo, perceived source direction and/or distance, or reflection time delay to provide guidance for tracing a perimeter of said representation of said object.

9. An audio display system according to claim 1, wherein said object mapping unit is further configured to generate a map identifying locations within said interaction field that correspond to a representation of a second object to be displayed such that said interaction field is segmented into an exterior region and an interior region of said representation of said second object,
wherein said sound system is configured to provide a second object-locating sound when said pointing device addresses a location in said exterior region of said representation of said second object so as to guide a user to further address said interaction field at least one of closer to or further away from said interior region of said second object.

10. An audio display system according to claim 1, wherein said object mapping unit is further configured to generate a map identifying locations within said interaction field that correspond to a representation of each of a plurality of objects to be displayed such that said interaction field is segmented into an exterior region and an interior region for each said representation of each of said plurality of objects.

11. An audio display system according to claim 1, wherein said representation of said object to be displayed is a dynamic representation.

12. An audio display system according to claim 11, wherein said dynamic representation is a representation of at least one of a change in orientation, position, size, shape or configuration of said object.

13. An audio display system according to claim 1, wherein said pointing device is a touch-sensitive screen.

14. An audio display system according to claim 13, further comprising an embossed layer of material adapted to be placed over said touch-sensitive screen to serve as a tactile output device adapted to stimulate a sense of touch of a user.

15. An audio display system according to claim 1, wherein said pointing device is at least one of a surface-operable or aerial mouse.

16. An audio display system according to claim 1, wherein said pointing device is wearable location device.

17. An audio display system according to claim 16, wherein said wearable location device comprises at least one of an accelerometer or a gyroscope.

18. An audio display system according to claim 1, wherein said sound system comprises speakers.

19. An audio display system according to claim 1, wherein said sound system comprises at least one of headphones, earphones or earbuds.

20. An audio display system according to claim 1, wherein said sound system is further configured to provide speech feedback.

21. An audio display system according to claim 20, wherein said headphones comprise a location device such that said pointing device is integrated with a portion of said sound system.

22. An audio display system according to claim 1, further comprising a tactile output device adapted to stimulate a sense of touch of a user.

23. An audio display system according to claim 22, wherein said tactile output device is at least one of a structured material suitable to be touched by a user, a vibration device integrated with said pointing device, or a vibration device that is adapted to be attached to or worn by said user.

24. A method of providing an audio display, comprising:
generating a map identifying locations within an interaction field that correspond to a representation of an object to be displayed such that said interaction field is segmented into an exterior region and an interior region of said representation of said object;
receiving an input signal from a pointing device addressing a location within said interaction field; and
providing an object-locating sound with a sound system when said pointing device addresses a location in said exterior region so as to guide a user to further address said interaction field at least one of closer to or further away from said interior region of said object.

25. A computer-readable medium for providing an audio display, said computer-readable medium comprising computer-executable code which when executed by a computer causes the computer to:
generate a map identifying locations within an interaction field that correspond to a representation of an object to be displayed such that said interaction field is segmented into an exterior region and an interior region of said representation of said object;
receive an input signal from a pointing device addressing a location within said interaction field; and
provide instructions to a sound system to produce an object-locating sound when said pointing device addresses a location in said exterior region so as to guide a user to further address said interaction field at least one of closer to or further away from said interior region of said object.

26. An audio display system, comprising:
a pointing device configured to address locations within an interaction field;
a sound system adapted to communicate with said pointing device; and
an object mapping unit adapted to communicate with said sound system,
wherein said object mapping unit is configured to generate a map identifying locations within said interaction field that correspond to a representation of an object to be displayed using sound such that said interaction field is segmented into an exterior region and an interior region of said representation of said object.

27. An audio navigation system, comprising:
a pointing device configured to address locations within an interaction field;
a sound system adapted to communicate with said pointing device; and
an object mapping unit adapted to communicate with said sound system,
wherein said object mapping unit is configured to generate a map identifying locations within said interaction field that correspond to a representation of an object, and
wherein said sound system is configured to provide directional sounds for navigation using at least one of a general or a personal head related transfer function.

28. An audio navigation system according to claim 27, wherein said sound system uses said head related transfer function to generate sounds to guide a user around a perimeter of an object.
